(19) United States
(12) Patent Application Publication
(10) Pub. No.: US 2026/0133095 A1
(43) Pub. Date: May 14, 2026

(54) TESTING THE SURROUNDINGS SENSOR SYSTEM AND/OR PERCEPTION OF THE SURROUNDINGS OF A VEHICLE

(71) Applicant: Robert Bosch GmbH, Stuttgart (DE)

(72) Inventors: Imre Benedek Juhasz, Budapest (HU); Gergely Treplan, Budapest (HU); Csaba Marosi, Budapest (HU)

(21) Appl. No.: 18/686,384

(22) PCT Filed: Oct. 26, 2022
(86) PCT No.: PCT/EP2022/079983

§ 371 Date: Feb. 23, 2024

(30) Foreign Application Priority Data
Nov. 10, 2021 (DE) 10 2021 212 632.4

(51) Int. Cl. G01M 17/00; G01C 11/04; G06V 10/98; G06V 20/17

(52) U.S. Cl. CPC G01M 17/00; G01C 11/04; G06V 10/98; G06V 20/17

(57) ABSTRACT

A method for testing the surroundings sensor system and/or perception of the surroundings of a vehicle which operates on land or in water. The method includes obtaining model data of at least part of the surroundings of the vehicle, wherein the model data were created using data that characterizes the surroundings of the vehicle from at least one aerial perspective; transforming the model data into a reference system of the surroundings sensor system and/or perception of the surroundings; comparing the transformed model data with sensor data provided by the surroundings sensor system or the perception of the surroundings and/or with processing results of the sensor data; using the result of the comparison to evaluate the extent to which the sensor data and/or processing results are in line with the real situation in the surroundings of the vehicle.

### FIELD

The present invention relates to testing the surroundings sensor system and/or perception of the surroundings of vehicles, in particular for the purposes of driving assistance systems and systems for at least partially automated driving.

### BACKGROUND INFORMATION

Driving assistance systems and systems for at least partially automated driving make decisions about interventions into the vehicle dynamics of the vehicle on the basis of a perception of the surroundings. Such a perception of the surroundings is typically obtained by evaluating measurement data recorded by a surroundings sensor system of the vehicle. For example, the perception of the surroundings can indicate what objects are in the surroundings of the vehicle and which areas are freely negotiable.

The more accurate the perception of the surroundings, the better the decisions about the future vehicle dynamics of the vehicle that can be made by the aforementioned systems tend to be. However, the costs for the surroundings sensor systems and the downstream evaluation are growing disproportionately as the need for this accuracy increases. For series production for vehicles, it is therefore common to use less expensive hardware for the surroundings sensor systems and the evaluation and to at least randomly check the plausibility of the obtained perception of the surroundings against a reference having a known accuracy. If the perception of the surroundings proves to be consistently plausible, it is assumed that it corresponds sufficiently accurately to the real situation in the surroundings of the vehicle.

### SUMMARY

As part of the present invention, a method for testing the surroundings sensor system and/or perception of the surroundings of a vehicle which operates on land or in water was developed.

A surroundings sensor system is understood to be any arrangement that comprises one or more sensors and is configured to record sensor data relating to one or more physical measured variables from the surroundings of the vehicle. These sensor data respectively represent values of the measured variables and can, for instance, in particular indicate a spatial distribution of values of the measured variables. Sensor data can include images, video images, ultrasound images, thermal images, radar data and/or LiDAR data, for example. The sensor data therefore do not necessarily have to be available in a two or three-dimensional grid, but can also be available as point clouds, for example.

A perception of the surroundings is understood to be any processing result of sensor data from the surroundings sensor system that provides information about the semantic content of the situation in the surroundings of the vehicle and thus provides a better basis for decisions about future vehicle dynamics than the original sensor data. A perception of the surroundings can, for instance, indicate what objects are located where in the surroundings of the vehicle.

As part of the method of the present invention, model data of at least part of the surroundings of the vehicle is obtained. These model data were created using data that characterizes the surroundings of the vehicle from at least one aerial perspective. In particular images that show the surroundings of the vehicle from the at least one aerial perspective, for instance, can be used as the data. It is, however, also possible to use data from all other measurement modalities mentioned above in the context of the sensor data, for instance. The model data can in particular include an evaluation of the images with respect to at least one aspect also evaluated by the perception of the surroundings from the sensor data, for example.

The model data can, for instance, include a depiction of the surroundings of the vehicle in the form of one or more images, and/or in the form of one or more point clouds. However, the model data can also be of the same or a similar data type as the processing results provided by the perception of the surroundings, for example, and include a semantic segmentation or other indication of objects in the surroundings of the vehicle.

The aerial perspective can be the perspective of any aircraft or spacecraft. The data from the aerial perspective can have been recorded by at least one drone, by at least one aircraft, by at least one airship or also by at least one satellite, for example.

According to an example embodiment of the present invention, the model data are transformed into a reference system of the surroundings sensor system and/or perception of the surroundings. The transformed model data can in particular indicate sensor data and/or a perception of the surroundings, for instance, that would ideally have to result from the perspective of the vehicle if the model corresponded exactly to the real situation in the surroundings of the vehicle.

The transformed model data are compared with sensor data provided by the surroundings sensor system or the perception of the surroundings and/or with processing results of said sensor data. The result of this comparison is used to evaluate the extent to which the sensor data and/or processing results are in line with the real situation in the surroundings of the vehicle.

The use especially of model data that characterizes the surroundings of the vehicle from at least one aerial perspective to test a surroundings sensor system and/or perception of the surroundings that operates from a completely different perspective appears at first glance to be disadvantageous, because the additional transformation into the reference system of the surroundings sensor system or perception of the surroundings becomes necessary. However, this apparent disadvantage is more than offset for two reasons.

Firstly, the surroundings of the vehicle can be viewed more completely from an aerial perspective than from the perspective of the vehicle itself. In most situations, the surroundings of the vehicle are completely visible from one or more aerial perspectives. Traffic participants and other objects in particular do not obscure one another. Once the situation is completely understood, it can be computationally transformed into numerous perspectives of vehicles. A model that is created directly from the perspective of the vehicle, on the other hand, can only be used for that perspective. Information about objects that are present but obscured in this perspective is not physically acquired, and can therefore not be achieved by transformation into a different perspective, no matter how complex the transformation. This means that once model data has been recorded, it can be used in a variety of ways.

Of course, the acquisition of data from an aerial perspective cannot be complete in all situations. Tunnels, for example, cannot be seen into from an aerial perspective, and at highway interchanges the lanes are sometimes one above the another on multiple planes. However, it is not necessary for the model to have comparison data available for testing the surroundings sensor system or perception of the surroundings for every time and place in which the vehicle is located. It is instead sufficient to randomly carry out tests with model data at specific time and/or spatial intervals. If the sensor data and/or processing results ascertained in the vehicle during these random tests are in line with the transformed model data, it can be assumed that the surroundings sensor system or the perception of the surroundings are also functioning correctly in the situations that are not specifically being tested.

Secondly, model data can be acquired more quickly and more cost-effectively from an aerial perspective than with test drives. An aerial view can capture an entire traffic situation at a traffic intersection in one go, for example. To capture the same traffic situation from the perspective of the vehicle, a large number of test drives would have to be carried out in all possible directions of travel and traffic relationships at this traffic intersection.

The method according to the present invention can, for instance, in particular be used in the validation of the surroundings sensor system and/or perception of the surroundings of a vehicle during development. A test drive of a test vehicle that is equipped with the surroundings sensor system or perception of the surroundings to be tested can be observed with one or more drones, for example. This makes it possible to obtain model data that relate specifically to this test drive and are therefore most comparable with the sensor data or processing results.

During normal driving operation of vehicles, there is usually no model data available that relates to that specific trip. However, at least a limited comparison with the model data is still possible. For instance, the vehicle should in particular perceive lane markings, structural lane boundaries, buildings and/or trees, that change only very rarely or not at all, where they are predicted to be by the model.

In a particularly advantageous embodiment of the present invention, the extent to which the same types of objects are in the same locations as evidenced by the transformed model data on the one hand and as evidenced by the perception of the surroundings on the other hand is ascertained as part of the comparison. The information about what objects are located in which locations is the most important basis for decisions about the future vehicle dynamics of the vehicle. Checking the plausibility against the model data makes it possible to identify a broad class of malfunctions of the surroundings sensor system or perception of the surroundings. For example, if objects are detected at incorrect locations, this can indicate that the vehicle is not localizing itself with sufficient accuracy, for instance, or that the surroundings sensor system is not properly adjusted or calibrated. Misclassifications of objects or completely missing objects in the processing result provided by the perception of the surroundings can, for instance, indicate that the quality of the sensor data recorded by the surroundings sensor system is too poor or that an image classifier being used in the surroundings sensor system is not up to date. Targeted manipulations with so-called “adversarial examples” can also be discovered. In this type of manipulation, specific patterns, which lead to an incorrect classification when the sensor data is processed in the perception of the surroundings, are deliberately introduced into the surroundings of the vehicle. In experiments, it has already been possible to disrupt the processing of the recorded images in a perception of the surroundings, for example by applying a semi-transparent film with a special dot pattern to a camera lens, in such a way that all pedestrians disappear in the semantic segmentation of the surroundings of the vehicle provided by this perception of the surroundings.

In a further particularly advantageous embodiment of the present invention, an accuracy of the temporal synchronization between the transformed model data on the one hand and the processing results provided by the perception of the surroundings on the other hand is ascertained. This ascertainment can include a passive measurement of the temporal synchronization. Particularly advantageously, however, the transformed model data on the one hand and the processing results provided by the perception of the surroundings on the other hand are actively synchronized with one another. For this purpose, for instance, a synchronization signal can be used that is recorded simultaneously by the vehicle and by the drones being used to create the model. After active synchronization, the accuracy of the temporal synchronization can be set to a variance of zero (for perfect synchronization), or to the residual inaccuracy that remains after synchronization.

The comparison of what objects are at which locations as evidenced by the transformed model data on the one hand and as evidenced by the processing results from the perception of the surroundings on the other hand is made dependent on a probability that the respective object will not change its position and/or orientation within a period of time corresponding to said accuracy. The temporal accuracy ascertained by passive measurement and/or active synchronization therefore specifies which types of objects are to be used in a subsequent spatial comparison between transformed model data on the one hand and sensor data or processing results on the other hand.

If the model data refer to the same point in time as the sensor data, or the processing results ascertained from these sensor data by the perception of the surroundings, the adjustment with regard to the respective detected objects and their positions is possible without any limitations. If the model data on the one hand and the sensor data or processing results on the other hand are not completely time-synchronous, the positions of certain objects may have changed within a period of time that corresponds to the time offset. In particular vehicles, for example, or other traffic participants, may have moved on during this period of time. Static objects, on the other hand, will still be in the same place. With respect to these objects, therefore, the comparison is still useful even if there is a time offset.

In particular lane markings, lane boundaries, buildings and/or trees, for example, can be included in the comparison independent of the accuracy of the temporal synchronization.

As discussed above, the acquisition of the situation in the surroundings of the vehicle tends to be more complete from an aerial perspective than from the perspective of a vehicle. The comparison of the transformed model data with the sensor data or processing results ascertained on board the vehicle can therefore, for instance, in particular include a test of what objects can be acquired with the surroundings sensor system of the vehicle and to what extent as evidenced by the transformed model data. If certain objects are not visible from the perspective of the vehicle, their absence in the sensor data or processing results cannot “blamed” on the surroundings sensor system or the perception of the surroundings.

In a further advantageous embodiment of the present invention, in response to the determination that the sensor data and/or processing results are not in line with the real situation in the surroundings of the vehicle, at least one additional sensor of the surroundings sensor system and/or an additional perception of the surroundings is activated. Alternatively or also in combination with this, at least one driving assistance system or system for at least partially automated driving can be restricted or deactivated in terms of its functionality.

For example, a camera-based surroundings sensor system can be temporarily disrupted by precipitation or sunlight falling directly onto the image sensor. In that case, an additional sensor modality can be used that is not susceptible to the respective interference, for example radar. The use of a different sensor modality can moreover also hide the influence of the mentioned manipulation with an “adversarial example”.

The aforementioned manipulation can also be hidden by using an additional perception of the surroundings, for instance. An additional neural network can be used for this purpose, for example, that is structured differently and/or trained differently than the neural network of the original perception of the surroundings.

Alternatively or also in combination with this, parameters that characterize the behavior of the surroundings sensor system and/or perception of the surroundings can be optimized with the objective of bringing the sensor data and/or processing results more into line with the real situation in the surroundings of the vehicle. This is in particular advantageous when using the method in the development process of the surroundings sensor system or the perception of the surroundings. In this application, validation on the basis of test drives that are observed from the aerial perspective can therefore provide feedback about the extent to which the surroundings sensor system and/or the perception of the surroundings is still in need of optimization.

Parameters that characterize the behavior of the surroundings sensor system can in particular be operating parameters for Cameras or other sensors, for example. For instance, if the available bandwidth for the data stream is limited, it can be possible to find an optimum compromise between high resolution on the one hand and a high frame rate per second on the other.

Parameters that characterize the behavior of the perception of the surroundings can in particular include parameters (such as weights) of neural networks being used in the evaluation of the sensor data, for instance.

The present invention also provides a method for creating a model for the surroundings of a vehicle. This model is configured to be used in the above-described method for testing the surroundings sensor system and/or perception of the surroundings.

According to an example embodiment of the present invention, this method involves obtaining data that characterize the surroundings of the vehicle from the aerial perspectives of a plurality of drones. In particular images that show the surroundings of the vehicle from the at least one aerial perspective, for instance, can be used as the data. It is, however, also possible to use data from all other measurement modalities mentioned above in the context of the sensor data, for instance. At least one distance and/or orientation of the respective drone relative to the vehicle is ascertained using this data and previously known information about the appearance and/or geometry of the vehicle. The data and/or information derived from said data are then merged on the basis of these distances and/or orientations to form the model. Alternatively or in combination with this, the distance between the vehicle and the respective drone can be ascertained using other information, such as GPS signals, other electromagnetic signals, ultrasonic waves, distances from specified stationary objects or results of triangulation. For triangulation, for example, the plurality of drones with their different perspectives relative to the vehicle can in particular collaborate.

The method according to the present invention therefore only requires information relating to the vehicle as previously known information. The positions of the drones are needed as well for merging. These positions are acquired in flight by default. The method can be further supported by applying markings with contrast that is particularly easy to see from the air to the vehicle.

Merging the data recorded by a plurality of drones, such as images, can improve the quality of the model. On the other hand, the plurality of drones can also work together to track one and the same vehicle. Depending on the category of road on which the vehicle is traveling, the vehicle may travel faster than a drone can fly. In that case, the vehicle can be “handed over” from the spatial acquisition range of one drone to the spatial acquisition range of another drone. This is somewhat analogous to handing over moving mobile phone users from one radio cell to the next.

The ascertained information about the distance and/or orientation of the respective drone relative to the vehicle can be used not only to form the model, but also to transform this model into the reference system of the surroundings sensor system, or the perception of the surroundings, of the vehicle.

In a particularly advantageous embodiment of the present invention, the model includes a spatial distribution of at least one variable of interest in the surroundings of the vehicle. A parameterized approach can be made for such a spatial distribution, for instance, and the parameters of this approach can be ascertained using the recorded data or the information derived from said data.

Merging the data, or the information, to form the model can in particular include ascertaining equations in the variable of interest from the data, for example, and solving a system of equations consisting of these equations. Alternatively or in combination with this, parameters of a parameterized distribution of the variable can appear as unknowns in these equations as well. The system of equations then contains more equations relating to each location of interest, the more information relating to the sought variable is available overall at that location. Contradictions, for example between the information provided by a plurality of drones, can then be resolved automatically in such a way that the resulting error is minimized. The density of available information can spatially vary greatly. There may therefore be locations for which a lot of information is available, but also locations for which very little information is available.

In a particularly advantageous embodiment of the present invention, the model includes a semantic segmentation of the surroundings of the vehicle with respect to which locations are occupied by objects of which type as a spatial distribution of a variable of interest. The occupancy with objects of specific types is therefore a variable of interest, the spatial distribution of which is ascertained. As discussed above, the occupancy of locations with objects of specific types is the most important basis for decisions about interventions into the vehicle dynamics of vehicles.

In a further advantageous embodiment of the present invention, the merging to form the model includes reconstructing the geometry of at least one object in the surroundings of the vehicle by means of photogrammetry from images as data. It is thus also possible to ascertain the heights of objects, for example, so that the occupancy of locations with objects can be ascertained not only in two but in three dimensions. The size of the shadows cast by objects, for example, can also be used to ascertain the heights of objects.

In a further advantageous embodiment of the present invention, the merging to form the model includes correlating data recorded at different points in time by different drones and/or information derived from said data with one another on the basis of said points in time. For example, if one and the same vehicle is first traveling within the acquisition range of a first drone and then within the acquisition range of a second drone, the data, or the information derived from said data, from the two views of the vehicle from the respective drones can be offset against one another.

The method can in particular be fully or partly computer-implemented. The present invention therefore also relates to a computer program comprising machine-readable instructions, which, when they are executed on one or more computers, cause the computer(s) to carry out one of the described methods of the present invention. In this sense, control units for vehicles and embedded systems for technical devices that are likewise capable of executing machine-readable instructions are also to be regarded as computers.

The present invention furthermore also relates to a machine-readable data carrier and/or to a download product comprising said computer program. A download product is a digital product that can be transmitted via a data network, i.e., can be downloaded by a user of the data network, and can be offered for sale in an online shop for immediate download, for example.

A computer can moreover be equipped with the computer program, with the machine-readable data carrier or with the download product, according to the present invention.

Further measures improving the present invention are shown in more detail below, together with the description of the preferred embodiment examples of the present invention, with reference to the figures.

### BRIEF DESCRIPTION OF THE DRAWINGS

FIG. 1 shows an embodiment example of the method 100 for testing the surroundings sensor system and/or perception of the surroundings of a vehicle 1, according to the present invention.

FIG. 2 shows an embodiment example of the method 200 for creating a model 3, according to an example embodiment of the present invention.

FIGS. 3A-3C show traffic situation 10 as an application example for the method 100 according to the present invention.

### DETAILED DESCRIPTION OF EXAMPLE EMBODIMENTS

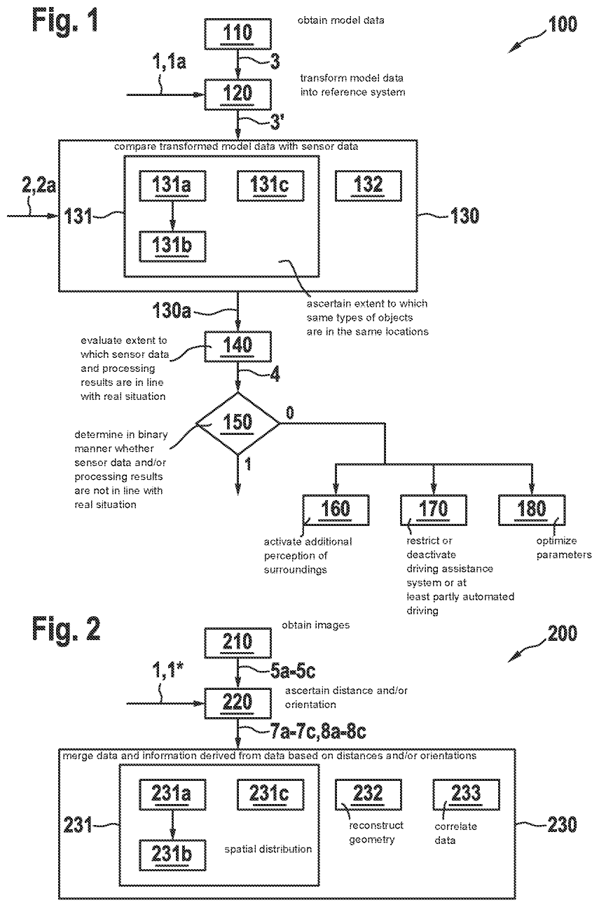

FIG. 1 is a schematic flowchart of an embodiment example of the method 100 for testing the surroundings sensor system and/or perception of the surroundings of a vehicle 1.

In Step 110, model data 3 of at least part of the surroundings of the vehicle 1 are obtained. These model data 3 were created using data that characterizes the surroundings of the vehicle 1 from at least one aerial perspective.

In Step 120, the model data 3 is transformed into a reference system la of the surroundings sensor system and/or perception of the surroundings of the vehicle 1.

In Step 130, the transformed model data 3′are compared with sensor data 2 provided by the surroundings sensor system or the perception of the surroundings and/or with processing results 2a of said sensor data.

The result 130a of this comparison 130 is used in Step 140 to evaluate the extent to which the sensor data 2 and/or processing results 2a are in line with the real situation in the surroundings of the vehicle 1. The degree of agreement is labeled with the reference sign 4.

In Step 150, said measure 4 and any criterion are used to determine in a binary manner whether the sensor data 2 and/or processing results 2a are not in line with the real situation in the surroundings of the vehicle 1 is ascertained binarily based on. If this is not the case (truth value 0), at least one additional sensor of the surroundings sensor system and/or an additional perception of the surroundings can be activated in Step 160. Alternatively or also in combination with this, at least one driving assistance system or system for at least partially automated driving can be restricted or deactivated in terms of its functionality in Step 170. Alternatively or in combination with this, in Step 180, parameters that characterize the behavior of the surroundings sensor system and/or perception of the surroundings can furthermore be optimized with the objective of bringing the sensor data 2 and/or processing results 2a more into line with the real situation in the surroundings of the vehicle 1.

According to Block 131, the extent to which the same types of objects are in the same locations as evidenced by the transformed model data (3′) on the one hand and as evidenced by the perception of the surroundings on the other hand is ascertained as part of the comparison 130.

In this context, according to Block 131a, an accuracy of the temporal synchronization between the transformed model data 3′ on the one hand and the processing results 2a provided by the perception of the surroundings on the other hand can be ascertained. According to Block 131b, the comparison can be made dependent on a probability that the respective object will not change its position and/or orientation within a period of time corresponding to said accuracy. According to Block 131c, in particular lane markings, lane boundaries, buildings and/or trees can be included in the comparison 130 independent of the accuracy of the temporal synchronization. As discussed above, an accuracy of the temporal synchronization can be measured passively, but can also be actively established.

According to Block 132, the comparison 130 can include a test to see which objects can be acquired with the surroundings sensor system of the vehicle 1 and to what extent as evidenced by the transformed model data 3′.

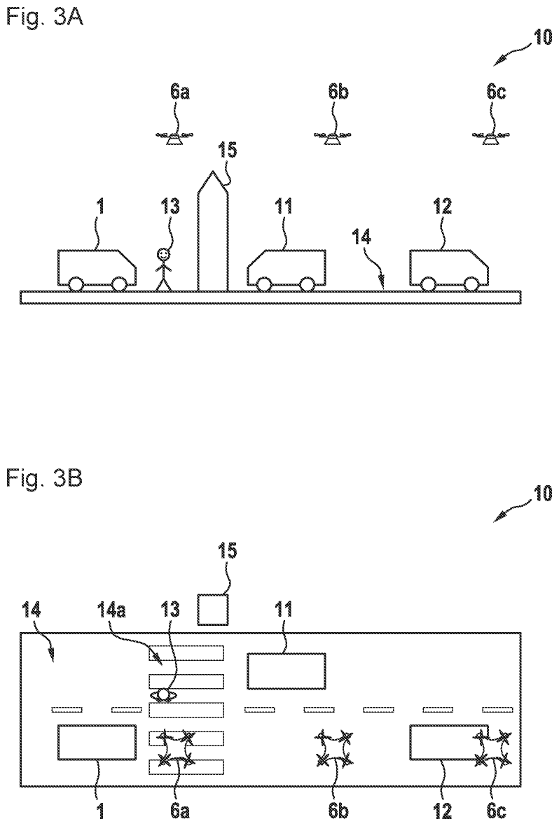

FIG. 2 shows a schematic flowchart of an embodiment example of the method 200 for creating a model 3 for the surroundings of a vehicle 1. This model 3 is provided for use in the method 100 described above.

In Step 210, data 5a-5c, such as images, that characterize the surroundings of the vehicle 1 from the aerial perspectives of a plurality of drones 6a-6c are obtained.

In Step 220, at least one distance 7a-7c and/or orientation 8a-8c of the respective drone 6a-6c relative to the vehicle 1 is ascertained using this data 5c-5c and previously known information 1* about the appearance and/or geometry of the vehicle 1.

In Step 230, the data 5a-5c, and/or information derived from said data 5a-5c, are merged on the basis of these distances 7a-7c and/or orientations 8a-8c to form the model 3.

According to Block 231, the model 3 can include a spatial distribution of at least one variable of interest in the surroundings of the vehicle 1.

According to Block 231a, equations in the variable of interest can be ascertained from the data 5a-5c. A system of equations consisting of these equations can then be solved according to Block 231b.

According to Block 231c, the model 3 can include a semantic segmentation of the surroundings of the vehicle 1 with respect to which locations are occupied by objects of which type as a spatial distribution of a variable of interest.

According to Block 232, the merging 230 to form the model 3 can include reconstructing the geometry of at least one object in the surroundings of the vehicle by means of photogrammetry from images as data 5a-5c.

According to Block 233, the merging 230 to form the model 3 can include correlating data 5a-5c recorded at different points in time by different drones 6a-6c and/or information derived from said data 5a-5c with one another on the basis of said points in time.

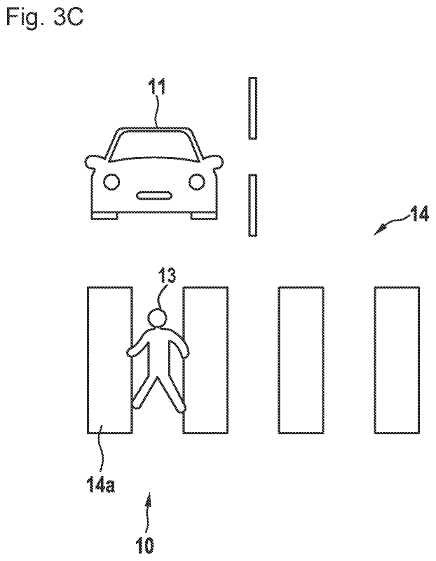

FIGS. 3A-3C shows an example of a traffic situation 10 that can be observed with three drones 6a-6c to create a model 3 according to the method 200. The traffic situation 10 includes
a road 14 with a crosswalk 14a;
a vehicle 1, which is traveling on the road 14 and the surroundings sensor system and/or perception of the surroundings of which are to be tested later with the model 3 to be created;
two other vehicles 11 and 12 that are traveling on the road 14;
a pedestrian 13 crossing the road 14 on the crosswalk 14a; and
a pillar 15 on the edge of the road 14.

FIG. 3A shows a side view and FIG. 3B shows a top view. The comparison shows that the aerial perspective provides a much better overview of the traffic situation 10 and can capture the traffic situation much more clearly than the side view. The crosswalk 14a is not visible in the side view, for example, and it is also difficult to distinguish in which direction the vehicles 1, 11 and 12 are respectively traveling on the road 14.

FIG. 3C shows the traffic situation 10 from the perspective of a driver of the vehicle 11. Already based alone on the limited field of view, there is significantly less information available from this perspective. The left edge of the crosswalk 14a is missing, as is the pillar 15, so that the driver cannot see whether another person is stepping onto the crosswalk 14a from the left, for instance. The preceding vehicle 12 is missing as well. Only the front of the oncoming vehicle 11 is visible, which makes it difficult to estimate its length, for example.

1-15. (canceled)

16. A method for testing a surroundings sensor system and/or perception of surroundings of a vehicle which operates on land or in water, comprising the following steps:
obtaining model data of at least part of the surroundings of the vehicle, wherein the model data were created using data that characterizes the surroundings of the vehicle from at least one aerial perspective;
transforming the model data into a reference system of the surroundings sensor system and/or perception of the surroundings;
comparing the transformed model data: (i) with sensor data provided by the surroundings sensor system or the perception of the surroundings and/or (ii) with processing results of the sensor data;
using a result of the comparison to evaluate an extent to which the sensor data and/or processing results are in line with a real situation in the surroundings of the vehicle.

17. The method according to claim 16, wherein an extent to which the same types of objects are in the same locations as evidenced by the transformed model data on the one hand and as evidenced by the perception of the surroundings on the other hand is ascertained as part of the comparison.

18. The method according to claim 17, wherein:
an accuracy of a temporal synchronization between the transformed model data on the one hand and the processing results provided by the perception of the surroundings on the other hand is ascertained, and
the comparison is dependent on a probability that a respective object will not change its position and/or orientation within a period of time corresponding to the accuracy

19. The method according to claim 18, wherein lane markings and/or lane boundaries and/or buildings and/or trees are included in the comparison independent of the accuracy of the temporal synchronization.

20. The method according to claim 16, wherein the comparison includes a test to see which objects can be acquired with the surroundings sensor system of the vehicle and to what extent, as evidenced by the transformed model data.

21. The method according to claim 16, wherein, in response to a determination that the sensor data and/or processing results are not in line with the real world situation in the surroundings of the vehicle:
at least one additional sensor of the surroundings sensor system and/or an additional perception of the surroundings is activated, and/or
at least one driving assistance system or system for at least partially automated driving is restricted or deactivated in terms of its functionality, and/or
parameters that characterize a behavior of the surroundings sensor system and/or perception of the surroundings are optimized with an objective of bringing the sensor data and/or processing results more into line with the real situation in the surroundings of the vehicle.

22. A method for creating a model for surroundings of a vehicle for testing a surroundings sensor system and/or perception of the surroundings, comprising the following steps:
obtaining data that characterize the surroundings of the vehicle from an aerial perspectives of a plurality of drones;
using the obtained data and previously known information about an appearance and/or geometry of the vehicle to ascertain at least one distance and/or orientation of each of the drones relative to the vehicle;
based on the distances and/or the orientations, merging the obtained data and/or information derived from the obtained data to form the model.

23. The method according to claim 22, wherein the model includes a spatial distribution of at least one variable of interest in the surroundings of the vehicle.

24. The method according to claim 23, wherein the merging to form the model includes ascertaining equations in the variable of interest from the data and solving a system of equations including the ascertained equations.

25. The method according to claim 22, wherein the model includes a semantic segmentation of the surroundings of the vehicle with respect to which locations are occupied by objects of which type as a spatial distribution of a variable of interest.

26. The method according to claim 22, wherein the merging to form the model includes reconstructing a geometry of at least one object in the surroundings of the vehicle using photogrammetry from images as data.

27. The method according to claim 22, wherein the merging to form the model includes correlating data recorded at different points in time by different drones and/or information derived from the data recorded at the different points in time by the different drones with one another based on the different points in time.

28. A non-transitory machine-readable data carrier on which is stored a computer program for testing a surroundings sensor system and/or perception of surroundings of a vehicle which operates on land or in water, the computer program, when executed by one or more computers, causing the one or more computers to perform the following steps:
obtaining model data of at least part of the surroundings of the vehicle, wherein the model data were created using data that characterizes the surroundings of the vehicle from at least one aerial perspective;
transforming the model data into a reference system of the surroundings sensor system and/or perception of the surroundings;
comparing the transformed model data: (i) with sensor data provided by the surroundings sensor system or the perception of the surroundings and/or (ii) with processing results of the sensor data;
using a result of the comparison to evaluate an extent to which the sensor data and/or processing results are in line with a real situation in the surroundings of the vehicle.

29. One or more computers, comprising a non-transitory machine-readable data carrier on which is stored a computer program for testing a surroundings sensor system and/or perception of surroundings of a vehicle which operates on land or in water, the computer program, when executed by the one or more computers, causing the one or more computers to perform the following steps:
obtaining model data of at least part of the surroundings of the vehicle, wherein the model data were created using data that characterizes the surroundings of the vehicle from at least one aerial perspective;
transforming the model data into a reference system of the surroundings sensor system and/or perception of the surroundings;
comparing the transformed model data: (i) with sensor data provided by the surroundings sensor system or the perception of the surroundings and/or (ii) with processing results of the sensor data;
using a result of the comparison to evaluate an extent to which the sensor data and/or processing results are in line with a real situation in the surroundings of the vehicle.
